(19) United States
(12) Patent Application Publication
(10) Pub. No.: US 2013/0090992 A1
(43) Pub. Date: Apr. 11, 2013

(54) EZ - coupon

(71) Applicants: Saed Sawaged, Egg Harbor Twp, NJ (US); Angelo Horiates, JR., Merchantville, NJ (US)

(72) Inventors: Saed Sawaged, Egg Harbor Twp, NJ (US); Angelo Horiates, JR., Merchantville, NJ (US)

(21) Appl. No.: 13/199,618

(22) Filed: Oct. 11, 2011

(51) Int. Cl. G06Q 30/02

(52) U.S. Cl. 705/14.1

(57) ABSTRACT

EZ Coupon is an integrated system that enables consumers to benefit from manufacturer and retail discounts without the need to scan coupons, or input coupon code(s) at checkouts. EZ Coupon accredits applicable discounts automatically for authorized customers. Authorization is given to customers by linking their existing or newly created accounts to EZ Coupon.

Manufacturer coupons, retailer coupons and un-advertised specials are inputted into the retailer database(s) in a specific file format. Once the customer scans the purchased product(s), the information in the retailer database is searched for applicable discounts. Once the discounts are identified and applied, the sale is consummated. EZ Coupon can be interfaced to currently-used retail and wholesale data networks and data warehouses.

Manufacturers are eligible to post manufacturer discounts to the retailer database which can be used in addition to retailer discounts. EZ Coupon can provide reports displaying discounts receivable from manufacturers for reconciliation purposes.

Our present invention has for its object to simplify and thereby to facilitate the issuance of electronically transmitted manufacturer and retailer coupons to consumers at the point of sale (cash register) thereby saving consumers time and expense of coupon cutting, maintenance and storage.

Consumer will be issued, upon a submitted application, certain customer cards for swiping at card readers or read through store optical scanners. The customer account number will be transmitted to the local store's database of discounted and/or sale items as well as to geographically situated computer servers where additional monetary savings can be had from participating manufacturers who have uploaded their discounts. If the patron's selected items, upon scanning universal product codes by the cashier of products selected, then any and all savings from discounts provided by in-store sales or manufacturer will be downloaded to the patron's final cashier settlement automatically. The local retailer can achieve automatic credit to their established manufacturer account and the manufacturer can achieve increased sales and customer goodwill from the discounts provided.

Waste and fraud are reduced to minimal levels for the manufacturer and retailer through total electronic processing of coupons and coupons for selected items can be directed to consumers as marketing plans dictate. Additional peripheral benefits would include the establishment of generic consumer information on purchasing habits and products purchased which can enable manufacturer and retailer managements to redirect resources to areas where consumer demand requires additional monitoring and response.

The method herein described is applicable to and provides for electronically generated consumer coupons or discounts for individuals who; 1) do not have time nor resources available to collect physical coupons; 2) do not or cannot collect coupons due to handicaps or language barriers and; 3) consumers, who for various reasons, are not aware of manufacturer or retailer coupons available, but, who nevertheless, desire to partake in the benefits of such coupons and discounts.

For the purpose of conveying a clear idea of the manner of carrying our said invention into practice, we have illustrated in the accompanying drawings a set of electrical appliances of currently known technological informational data transmission, processing and storage devices which can be composed of similar elements from varying hardware manufacturers but nevertheless operate within certain acceptable guidelines and parameters.

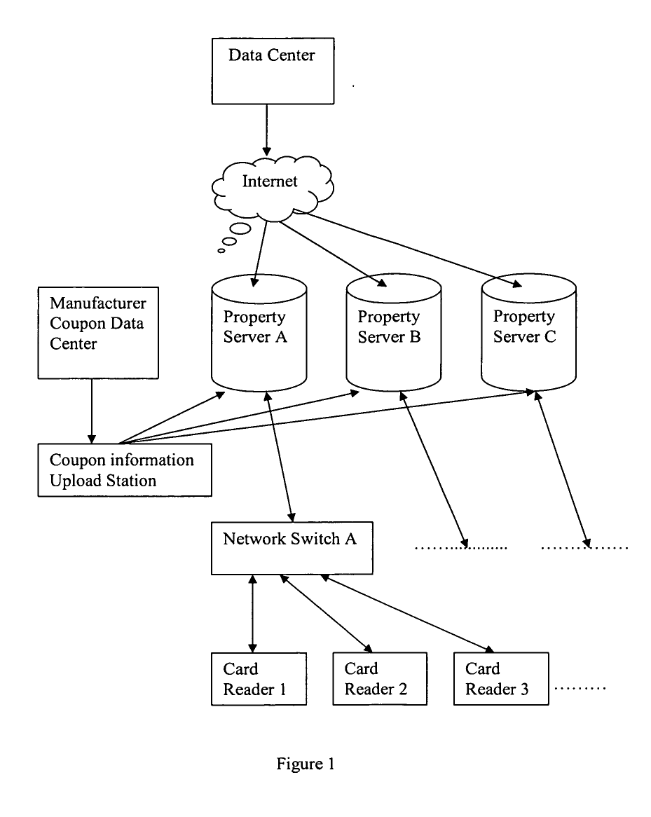

Current store network configuration, relevant to this application, encompasses scanners and card readers located at the point of sale, network switches that concentrate the transmission of data to and from the card readers and scanners, and a back-end server responsible of informational allocation and database population. FIG. 1, attached, details the network architecture that needed to automate coupon processing. Coupon manufacturers must provide coupon information in a form of an electronic file formatted in such a manner that can be populated within the property database. The file format will depend on the property's database. More than one file format is expected to be designed. Once the coupon file(s) are generated, the coupon file must be loaded within the property database. This can be achieved by either file transfer using disk drives or online.

The property back-end server must also be updated with software than will apply the coupon file savings to all eligible customers. The software will also determine weather or not the customer is approved to receive the savings.

The data center will have dedicated storage capacity for each enrolled manufacturer unaccessible by anyone other than the manufacturer. The manufacturer will upload daily, weekly or any other time period, advertised or un-advertised specials to which retail locations can download from and provide to the consumer. Retailers would require secure access provided by manufacturers and the data center(s) administrators. The transmission of information from the data centers to the retailers and back to the data centers is accomplished through high speed secured internet connections. Similarly, data transmission can be made at certain time intervals between a manufacturer data center and a retailer data center which information would subsequently be transmitted down to individual stores of the retailer, all stores of the retailer or certain targeted stores of the retailer, all of which would provide a corporate control over coupon issuance and collection aspects. Each individual store or retailer would have its own information technology property server which is connected to the corporate data center or the manufacturer data center or both through high speed interne connections, in order to provide the fastest service possible to the consumer at the checkout line.

1. What we claim is that we have found a method where manufacturer coupons can be applied to store customers automatically and without the need for coupon cutting: The methodology of which utilize current implementation of store networks, servers, card readers and scanners without adding new hardware. Additional programming on the property server will be necessary to achieve this goal. Property administrators will be able to generate reports showing their customer shopping habits, eliminate fraud, and save customers, retailers, and manufacturers time and money.
